(19) United States
(12) Patent Application Publication
(10) Pub. No.: US 2021/0026634 A1
(43) Pub. Date: Jan. 28, 2021

(54) APPARATUS WITH REDUCED HARDWARE REGISTER SET USING REGISTER-EMULATING MEMORY LOCATION TO EMULATE ARCHITECTURAL REGISTER

(71) Applicant: ARM LIMITED, Cambridge (GB)

(72) Inventor: Simon John CRASKE, Cambridge, Cambridgeshire (GB)

(21) Appl. No.: 17/067,852

(22) Filed: Oct. 12, 2020

Related U.S. Application Data
(62) Division of application No. 15/222,994, filed on Jul. 29, 2016.

(30) Foreign Application Priority Data
Jul. 31, 2015 (GB) 1513524.7

(51) Int. Cl. G06F 9/30

(52) U.S. Cl. CPC G06F 9/30043

(57) ABSTRACT

An apparatus comprises processing circuitry for processing program instructions according to a predetermined architecture defining a number of architectural registers accessible in response to the program instructions. A set of hardware registers is provided in hardware. A storage capacity of the set of hardware registers is insufficient for storing all the data associated with the architectural registers of the pre-determined architecture. Control circuitry is responsive to the program instructions to transfer data between the hardware registers and at least one register-emulating memory location in memory for storing data corresponding to the architectural registers of the architecture.

### CROSS-REFERENCE

This application is a divisional of U.S. application Ser. No. 15/222,994, filed Jul. 29, 2016, which claims priority to GB Patent Application No. 1513524.7, filed Jul. 31, 2015, the entire contents of each of which are incorporated by reference.

### BACKGROUND

### Technical Field

The present technique relates to the field of data processing. More particularly, it relates to the provision of registers in hardware.

### Technical Background

It can desirable to reduce the circuit area and power consumed by a processing circuit. Even relatively simple processors can remain challenging to implement in mixed-signal processes and in particular in large geometry emerging processes such as printed logic. However, the extent to which the number of logic gates used for a given processor can be reduced is limited in part by the requirement to support a given processor architecture. The architecture may define certain functionality which must be provided by a processor in order to be compliant with the architecture, so that any code written in accordance with that architecture can be executed by that processor.

### SUMMARY

At least some examples provide an apparatus comprising:

processing circuitry to process program instructions in accordance with a predetermined architecture defining a plurality of architectural registers accessible in response to the program instructions; and

a set of hardware registers, wherein a storage capacity of the set of hardware registers is insufficient for storing data associated with all of the plurality of architectural registers of the predetermined architecture; and

control circuitry responsive to the program instructions to transfer data between the set of hardware registers and at least one register-emulating memory location in memory for storing data corresponding to at least one of the plurality of architectural registers of the predetermined architecture.

At least some examples provide a data processing method comprising:

receiving a program instruction to be processed according to a predetermined architecture defining a plurality of architectural registers accessible in response to the program instructions;

transferring data corresponding to at least one architectural register from a corresponding register-emulating memory location in memory to at least one of a set of hardware registers, wherein a storage capacity of the set of hardware registers is insufficient for storing data associated with all of the plurality of architectural registers of the predetermined architecture; and

processing the program instruction using the set of hardware registers.

At least some examples provide an apparatus comprising:

processing circuitry to perform data processing in response to program instructions;

a program counter register to store a program counter identifying a program instruction to be processed; and

control circuitry to write the program counter to memory in response to a predetermined type of instruction to be processed by said processing circuitry;

wherein the processing circuitry is configured to use said program counter register for storing at least one data value during processing of said predetermined type of instruction.

At least some examples provide a data processing method comprising:

storing in a program counter register a program counter identifying a program instruction to be processed;

in response to a predetermined type of instruction to be processed, writing the program counter to memory; and

using said program counter register for storing at least one data value during processing of said predetermined type of instruction.

At least some examples provide an apparatus comprising:

processing circuitry to perform data processing in response to program instructions;

at least one operand register to store at least one operand value;

an R-bit opcode register to store an opcode of a program instruction to be processed by the processing circuitry; and

control circuitry responsive to a program instruction having an S-bit opcode, where S>R, to load an R-bit portion of the opcode into the opcode register and to load a remaining portion of the opcode into one of said at least one operand register.

At least some examples provide a data processing method comprising:

loading an R-bit portion of an opcode of a program instruction to be processed into an R-bit opcode register;

detecting whether the loaded R-bit portion of the opcode corresponds to a portion of an S-bit opcode, where S>R; and

when the loaded R-bit portion of the opcode corresponds to the portion of the S-bit opcode, loading a remaining portion of the S-bit opcode into at least one operand register.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus having a set of hardware registers which is insufficient for storing data associated with all of the architectural registers defined by a predetermined architecture;

FIG. 2 illustrates an example of circuitry for controlling transfer of data between the hardware registers and register-emulating memory locations in memory;

FIGS. 3A and 3B comprise timing diagrams for a number of types of instructions supported by the architecture, illustrating pipelining of memory accesses for each kind of instruction;

FIG. 4 shows a method of processing an instruction using a register-emulating memory location to emulate an architectural register;

FIG. 5 shows a method of writing a program counter to memory to allow the program counter register to be used for another data value during processing of a given instruction;

FIG. 6 shows an example of multiplying circuitry for accumulating a result of the multiplication into the register used to store one of the input values being multiplied;

FIG. 7 shows a worked example of a multiplication for explaining the technique of FIG. 6; and

FIG. 8 illustrates a method of triggering an action when an instruction or data address of a current memory access matches a reference address.

Some specific examples will be described below. It will be appreciated that the invention is not limited to these particular examples.

### DESCRIPTION OF EXAMPLES

A given architecture may define a number of architectural registers to be made accessible to program instructions written according to that architecture. However, especially for less complex processors, providing a complete register file providing sufficient space for all the data of the required set of architectural registers may consume a significant fraction of the total gate count of the processor.

Instead, an apparatus may have a set of hardware registers (registers provided in hardware) with a storage capacity that is insufficient for storing data associated with all of the architectural registers of the predetermined architecture with which the processing circuitry is compatible. For example, at least one of the architectural registers may not have a dedicated hardware register, or a given hardware register could have fewer bits than the corresponding architectural register defined according to the architecture. For at least one of the registers defined according to the architecture, at least one register-emulating memory location may be allocated in memory, for storing data corresponding to that architectural register. Control circuitry may be responsive to certain program instructions to transfer data between the set of hardware registers and the corresponding register-emulating memory locations in memory. Effectively a portion of system memory can be used as a backing store for the architectural registers to allow the processing circuitry to comply with the predetermined architecture without having the full hardware cost of providing a complete hardware register set corresponding to all the architectural registers. While this may reduce performance, many processors are designed for applications where energy efficiency and low circuit area are more important factors than processing performance. For such applications, the present technique can allow the total gate count of the processor to be reduced significantly, while still complying with the requirements of the architecture.

In response to a program instruction which specifies at least one source architectural register for storing at least one operand value to be processed, the control circuitry may trigger a read operation to read the at least one operand value from a register-emulating memory location in memory corresponding to the specified source architectural register. When the memory returns the read operand value, it can be stored into at least one hardware register. The processing circuitry can then perform a given processing operation using the value loaded into the hardware register.

Similarly, when a program instruction specifies a destination architectural register for storing a result value to be generated in response to the program instruction, then a write operation can be triggered to write the result value generated by the processing circuitry to a register-emulating memory location in memory corresponding to the destination architectural register.

A write path for providing the result value to the memory may be directly coupled (or hardwired) to a predetermined hardware register of the set of hardware registers, which can help to improve write timing.

In some embodiments, a read operation for reading an operand value associated with a given architectural register from memory can be suppressed if the control circuitry determines that the value associated with that given architectural register is already stored in one of the set of hardware registers. For example, the apparatus may have some storage for storing one or more architectural register numbers associated with data currently stored in one or more operand registers of the hardware register set. For example, when a read operation loads the value associated with a given architectural register into one of the hardware registers, the architectural register number associated with that hardware register can be updated to match the register number of the given architectural register. Similarly, when a result of a processing operation is written back to one of the hardware registers, the architectural register number for that hardware register can be updated based on the number of the destination architectural register for the corresponding instruction. If an instruction refers to one of the architectural register numbers that is stored in the register number storage circuitry, then the corresponding load can be suppressed. Often the result of one instruction is an input operand to a subsequent instruction, or there may be a series of instructions which all require the same input operand, so by recording the register numbers of state resident in the hardware register file and not performing the loads if the correct value is already resident, performance can be improved.

On the other hand, other embodiments may perform the read operations for reading required operand values regardless of what state is already stored in the hardware registers. This can make control simpler as instruction timings are more predictable.

While the read or write operations discussed above may lead to some instructions requiring additional processing cycles, the performance overhead of the read/write operations can be reduced by pipelining at least part of the read/write operations. For example, at least part of the write operation for writing the result of a first instruction to memory may be performed in parallel with either part of a fetch operation for fetching a second instruction from memory or part of a read operation for reading from memory an operand value to be processed in response to the second instruction. For example, the write operation may include an address phase, when the address of the register-emulating memory location corresponding to the destination architectural register is provided to the memory, and a data phase, when the result value to be written to that memory location is provided to the memory. The fetch operation may include an address phase, when the address of a next instruction is provided to memory, and a data phase, when that instruction is read back from the memory. The read operation may similarly include an address phase, when the address of a register-emulating memory location corresponding to a source architectural register is provided to memory, and a data phase when the data value corresponding to that source architectural register is returned from memory. The bus connected to memory may typically have separate address and data channels and so an address for one memory access can be provided to memory in parallel with data being read or written for another memory access. Hence, the address phase of the write operation for a first instruction could be performed in parallel with a data phase of the fetch operation for fetching a second instruction. Also, the data phase of the write operation for a first instruction could be performed in parallel with the address phase of the read operation for a second instruction. This allows faster processing of the instructions.

The write operation for the first instruction can be deferred until after the fetch operation for the second instruction. This can be useful to allow the second instruction's opcode to be decoded in time for fetching any required source data from memory in the cycle after the write operation for the first operation, to save at least one processing cycle compared to performing the write operation for the first instruction before the fetch operation for the second instruction.

In some cases, a dedicated hardware register could be provided for at least one of the architectural registers defined in the architecture. In this case, instructions requiring access to that architectural register need not trigger a read operation or write operation as mentioned above.

On the other hand, at least one architectural register of the architecture may not have a fixed mapping to a corresponding hardware register. For instructions referring to such an architectural register, the read or write operations defined above may be performed.

In some cases, the set of hardware registers may comprise as few as two operand registers for storing operand values to be processed by the processing circuitry. In contrast, the architecture may define a larger number of general purpose architectural registers for storing operands. Instructions which refer to any of the general purpose architectural registers can have the corresponding values loaded from memory into one of the two operand registers provided in hardware. Providing two operand registers in hardware (as opposed to a larger number, e.g. 13, of general purpose registers defined in the architecture), can significantly reduce the circuit area of the processing apparatus.

However, there may be some types of instructions for which two N-bit operand registers may be insufficient for carrying out the corresponding processing operations. Some options for dealing with such cases are discussed below.

For example, some architectures may require support for a multiply instruction for multiplying two N-bit operand values to generate a result value. One would generally expect the multiply instruction to require more than 2N bits of hardware register storage to accommodate the two input operand values as well as accumulation of an accumulator value representing a sum of partial products of the operand values. However, there are a number of approaches which can be taken to deal with such instructions.

Some architectures may include a multiply instruction which takes two N-bit operand values and generates an N-bit result value which represents a least significant N bits of the product of the two operand values. Hence, while the true product of the two N-bit operands may have 2N bits, some architectures may specify an instruction which generates a half-width result corresponding to the least significant half of the product. For such instructions, it is possible to accumulate the N-bit result value into the same operand register that is used to store one of the N-bit input operands. The result can be generated using an iterative process for generating the N-bit result value in a number of steps with each step shifting out a bit of one of the operand values from a hardware operand register to accommodate an additional bit of an accumulator value representing the sum of partial products of the two operand values. This is possible because when a half width result is being generated multiplying by the most significant bit can only contribute to at most one bit of the N bit result, rather than N bits as would be the case for a multiplication generating a full 2N-bit product from two N-bit values. This avoids the need for a third operand register, to allow the overall hardware register set to be implemented more efficiently in hardware.

Another option is to use a program counter register which stores a program counter identifying a program instruction to be processed by the processing circuitry. In response to a predetermined type of instruction for triggering a corresponding processing operation, the control circuitry may write the program counter to memory and the processing circuitry may use the program counter register to store at least one data value during processing of that instruction. Hence, the program counter register can be used as some extra register space for accommodating data values that will not fit into the two operand registers to allow more complex operations to be implemented with less dedicated register storage. This is counter-intuitive since one would usually expect the program counter to be required for every instruction. However, the present technique recognises that the program counter can be temporarily written out to memory, and following completion of the required processing operation using the program counter register to store some other value, the control circuitry can then read the program counter back from memory and restore it to the program counter register ready for subsequent instructions. This approach can be used for any type of instruction for which the amount of operand register storage provided in the set of hardware registers is insufficient for carrying out that operation. For example, it can be used to allow a multiply or divide instruction to be implemented with only two operand registers, since the two operand registers and the program counter register can then be used to store the two input operands and an accumulator value for accumulating the result of the multiply or divide over a series of iterations (the accumulator value could be stored in any of the two operand registers or in the program counter register, with the other two of these three registers being used for storing the two input operands).

In some cases, the program counter could be written out to a reserved memory location specifically allocated for accommodating the program counter when required.

However, when the predetermined type of instruction specifies the same architectural register as both a source register and a destination register, then the control circuitry can write the program counter to the register-emulating memory location corresponding to that architectural register. As the result will be written back to the register-emulating memory location following the processing of the program instruction, then it is safe to temporarily overwrite that memory location with the program counter while the instruction is being processed, and then load the program counter back to the program counter register before the result is written back to memory. This avoids needing to allocate an additional memory location for the program counter.

The set of hardware registers may also include an opcode register for storing an opcode of a program instruction to be processed by the processing circuitry. For example, on fetching an instruction, the opcode of the instruction can be loaded into the opcode register and then the opcode can be decoded and used to control what operation is being performed by the processing circuitry. The term “opcode” may be used herein to refer to either the entire instruction encoding of the instruction (including any register specifying fields or immediate parameters within the instruction), or to the specific portion of the instruction encoding which identifies the type of instruction (excluding other register specifying fields or immediate fields).

In some cases, the predetermined architecture may support some instructions with different lengths of opcode. For example a given architecture may support both 16-bit and 32-bit opcodes. One approach may be to provide an opcode register with enough bits to accommodate the largest opcode supported by the architecture. However, for smaller instructions a significant portion of the register space remains unused.

To reduce the amount of register storage provided in hardware for an architecture supporting at least one instruction with an S-bit opcode, the hardware register set may include an R-bit opcode register, where R<S. Hence, the opcode register may not be large enough to store the opcode of all instructions supported by the architecture. In response to an instruction having the S-bit opcode, the control circuitry may load an R-bit portion of the opcode into the opcode register and then load a remaining portion of the opcode into at least one further register (e.g. a general purpose operand register) of the set of hardware registers. The entire S-bit opcode can then be decoded from the opcode register and the least one further register. The fetching of the remaining portion into the further register may take place in a subsequent cycle to the fetching of the initial portion into the opcode register. For example, decode circuitry may initially decode the R-bit portion placed in the opcode register to determine whether it is part of a larger S-bit opcode, and if so, trigger fetching of the remaining portion into the further register. In this way, the need to support at least one instruction with a large opcode does not require more register storage capacity to be provided. This approach can be particularly useful when there are relatively few instructions having an S-bit opcode compared to instructions having an R-bit opcode.

In some cases, the predetermined architecture may define more than one instruction set from which instructions can be executed by the processing circuitry. In this case, the architecture may also define in the set of architectural registers at least one bit of register storage for storing an instruction set indicating value for indicating which instruction set is the current instruction set from which instructions are being executed. Hence, the set of hardware registers may comprise at least one register bit for storing the instruction set indicating value.

However, not all instructions may be capable of changing which instruction set is executed. For a type of instruction following which a change of instruction set is prohibited by the architecture, the instruction set indicating value is unnecessary since the processing circuitry (or any decode circuitry for example) may be able to assume that the following instruction will be from the same instruction set as the current instruction.

Also, some examples of the predetermined architecture may require the instruction set indicating value to be provided in the architectural state for compatibility with code written for legacy systems which did provide multiple instruction sets, but that architecture itself may not actually support more than one instruction set, so that the instruction set indicating value is still provided in the architecture in case it is read by legacy code, but only ever takes one value. In this case, all instructions may be incapable of changing the instruction set indicating value as any attempt to change the instruction set indicating bit may lead to a fault.

Therefore, for at least one predetermined type of instruction the processing circuitry may reuse the at least one register bit provided in the set of hardware registers for storing the instruction set indicating value to instead indicate at least part of another parameter, to avoid needing to extend storage provided for the other parameter.

This approach can be particularly useful when the other parameter may often fit within a certain number of bits but occasionally requires at least one further bit. When the further bit is required for the other parameter then this may be encoded using the at least one bit of the hardware register file which would normally store the instruction set indicating value, to avoid permanently needing to provide additional bits of register storage in hardware for the other parameter.

For example, the other parameter may comprise an offset value for tracking a current phase of processing of a given instruction by the processing circuitry. For example, some instructions may require several phases of processing over a number of processing cycles. The set of hardware registers may comprise an offset register which stores an offset value for tracking which phase is the current phase being performed for the current instruction. Such an offset value can be useful for controlling the operation of the processing circuitry in each phase, e.g. for selecting addresses from which data is to be fetched from memory in each phase, or for controlling routing of signals within the processing circuitry. In some architectures, most instructions may only require a certain number of phases and so an offset value with a given number of bits may be provided to support that number of phases. However, there may be a limited number of instructions for which a larger number of phases is required and so this may require at least one additional bit for the offset value. To avoid needing to expand the size of the offset register provided in the hardware register set, for at least one predetermined type of instruction the additional bit of the offset value may be encoded using the at least one register bit of the hardware register set which normally would store the instruction set indicating value.

Some architectures may also support diagnostic functions such as debugging. For example, the architecture may define at least one architectural diagnostic register (e.g. a breakpoint or watchpoint register) for storing a reference address for which a predetermined action is to be triggered when a target address of a current memory access matches the reference address. For breakpoints, the reference address may be compared with an instruction address of an instruction fetched from memory. For watchpoints, the reference address may be compared with the address of a data value read from, or written to, memory. The at least one architectural diagnostic register can be emulated in memory in a similar way to the operand registers as discussed above. Hence, the apparatus may not have any hardware registers corresponding to the architectural diagnostic registers, but instead the corresponding reference addresses may be stored in memory and loaded into one of the hardware registers when required for a comparison with the target address of an instruction or data memory access. This avoids the hardware cost of providing all the architectural diagnostic registers in hardware.

However, loading the reference address from memory for every memory access performed by the system can cause a significant performance overhead. To reduce the performance cost of supporting the diagnostic functionality, at least one hardware diagnostic register may be provided to store a K-bit reference address corresponding to the J-bit reference address of a corresponding architectural diagnostic register (K<J). Hence, the hardware register stores a smaller reference address, not the full J-bit address. Comparison circuitry may detect, based on the K-bit reference address, whether the target address of a current memory access matches the K-bit reference address stored in the hardware diagnostic register, and when a match is detected, the comparison circuitry triggers loading of the full J-bit reference address from the register-emulating memory location representing the corresponding architectural diagnostic register. Having loaded the full J-bit reference address, a full comparison of the J-bit reference address with a J-bit target address can be performed.

Hence, a hardware diagnostic register which is smaller than the diagnostic register defined in the architecture may be used to reduce the number of times the full J-bit reference address is fetched from memory, to improve performance. A little additional overhead of implementing a K-bit hardware diagnostic register may be justified to avoid the large performance overhead associated with fetching the J-bit reference address for every single memory access. The size K of the hardware diagnostic register can be selected to trade off circuit area and performance—generally the larger K, the better the performance as fetching of the J-bit reference address will happen less often, but smaller K provides smaller circuit area.

In some cases, the K-bit reference address could be a K-bit portion of the J-bit reference address. In this case, the target address of the current memory access may be considered to match the K-bit reference address if a K-bit portion of the J-bit target address is the same as the stored K-bit reference address.

In other cases, the K-bit reference address may be derived from the J-bit reference address by applying a hash function, in which case the K-bit reference address may not correspond exactly to the bits of a portion of the J-bit reference address. The target address of the current memory access may be considered to match the K-bit reference address if the result of applying the hash function to the target address is the same as the K-bit reference address. A match against the K-bit reference address does not guarantee that the target address will match the full J-bit reference address, as there could be several different addresses for which the hash gives the same K-bit result, but a mismatching hash of the target address is enough to determine that the target address will not match the J-bit reference address, to allow the load of the J-bit reference address to be suppressed.

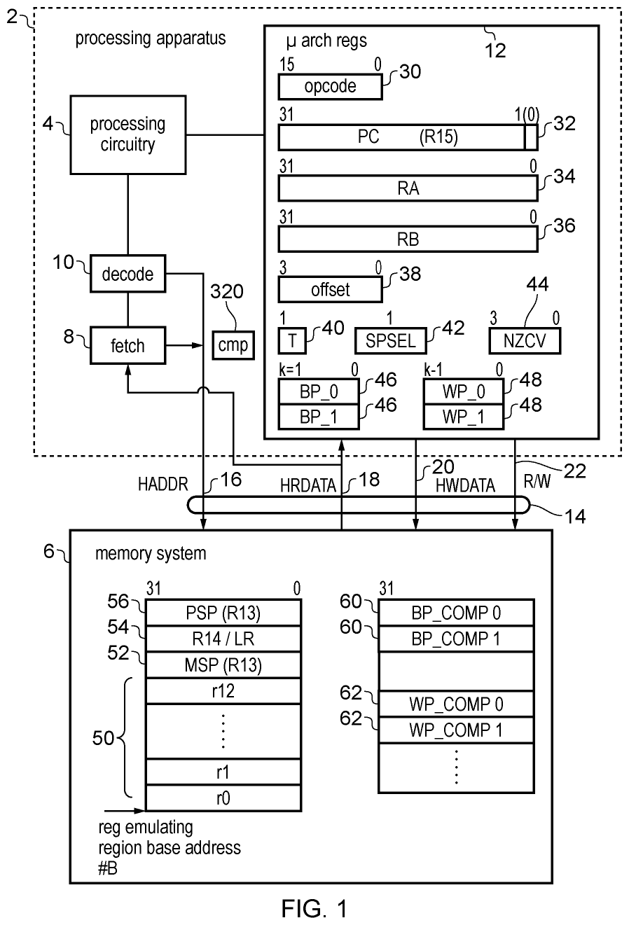

FIG. 1 schematically illustrates an example of a data processing apparatus 2, which may for example be a microprocessor, central processing unit (CPU) or graphics processing unit (GPU). The apparatus 2 comprises processing circuitry 4 for performing data processing operations in response to program instructions. Program instructions are fetched from a memory system 6 by fetch circuitry 8 and the fetched program instructions are decoded by decode circuitry 10. The decode circuitry 10 generates control signals for controlling the processing circuitry 4 to perform processing operations corresponding to the decoded program instructions. The processing apparatus 2 has a set of hardware registers 12 for storing various data values and control values used during processing of the program instructions.

The data processing apparatus 2 communicates with the memory system 6 via a bus 14. In this example the bus 14 comprises an address channel 16 for transmitting a memory address of an instruction or data value to be accessed to the memory system, a read data channel 18 for providing a read instruction or data value from the memory system 6 to the processing apparatus 2 and a write data channel 20 for providing a data value to be written to memory to the memory system 6. In other examples, separate instruction and data address and read channels could be provided. The bus also includes a control channel 22 for indicating whether the current operation is a read or write operation. For conciseness, the memory system 6 is shown in FIG. 1 as a single unit of memory but it will be appreciated that in some implementations the memory system 6 may comprise multiple memory units. For example the memory may comprise at least one cache and a main memory, where the cache caches a subset of the data from main memory for faster access by the processing apparatus 2. In some cases there could be multiple levels of cache in a hierarchical structure. Hence, references to “memory” herein should be interpreted as including a cache. While FIG. 1 shows the memory system 6 as being external to the processing apparatus 2, in other cases the memory system 6 could be considered part of the processing apparatus 2.

The processing circuitry 4 may process instructions according to a certain predetermined architecture. The predetermined architecture may be any known processor architecture. The following embodiments are described for the sake of example with the predetermined architecture being the ARMv6-M architecture provided by ARM Limited of Cambridge, UK. A copy of the ARM V6-M architecture reference manual can be obtained from arm.com or from other sources. The ARMv6-M architecture reference manual is herein incorporated by reference. However, it will be appreciated that other embodiments may perform processing in accordance with a different predetermined architecture, including other architectures provided by ARM® Limited, or architectures provided by other parties.

The predetermined architecture may define a certain number of architectural registers which are to be made accessible to program instructions of code written according to that architecture. For example, the architecture may define a certain number of general purpose operand registers for storing operand values to be processed by the processing circuitry 4 in response to instructions or results of the processing operations, as well as some special purpose registers for storing other values such as a program counter, stack pointer, etc.

For example, the architectural register set of the ARMv6-M architecture includes the following:
13 general purpose registers (R0, R1, . . . , R12) which can be specified as source or destination registers of a program instruction.
at least one stack pointer register (SP) for storing a stack pointer of a stack data structure in memory. The stack pointer register SP may also be referred to as register R13. In the ARMv6-M architecture, there are two banked versions of the stack pointer register, one corresponding to a main stack pointer (MSP) and another corresponding to a process stack pointer (PSP). Whether register reference R13 maps to MSP or PSP is selected based on stack pointer selection value (SPSEL) stored in at least one other architectural register (e.g. a control register).
a link register (LR) for storing a return address to which processing is to be directed following completion of a certain subroutine or exception handler. The link register may also be referred to as register R14.
a program counter register (PC) for storing a program counter indicating an address of a next program instruction to be processed by the processing circuitry 4. The PC register can also be referred to as register R15.
condition flags NZCV indicating a condition resulting from execution of a previous instruction, which can be used to control the outcome of subsequent conditional instructions
an instruction set indicating value T indicating which of several instruction sets is currently being executed by the processing circuitry. This can be useful for the decoder 10 to determine how to decode a given opcode. If there are only two supported instruction sets, the instruction set indicating value T may be a single bit, and if there are more than two instruction sets, the instruction set indicating value may comprise multiple bits.
one or more breakpoint comparison registers BP_COMPi for defining breakpoint reference addresses. When breakpointing is enabled, the architecture may require instruction addresses of instructions fetched from memory to be compared with each enabled breakpoint comparison register, and if there is a match with a given breakpoint comparison register then a corresponding action may be triggered. Another architectural register may define which breakpoint comparison registers are enabled, and which action is triggered when there is a match, for example.
one or more watchpoint comparison registers WP_COMPi for defining watchpoint reference addresses. When watchpointing is enabled, the architecture may require data addresses of read/write memory accesses to be compared with the reference address in each enabled watchpoint comparison register, and if there is a match with a given watchpoint comparison register, then a corresponding action may be triggered. Again, which registers are enabled, and the actions to be triggered, may be defined in another architectural register.
   It will be appreciated that this is not a complete list of all the architectural registers which could be provided. These are just some examples. It will be appreciated that the exact set of architectural registers supported depends on the particular architecture with which the processing circuitry 4 is compatible.

Hence, in general the predetermined architecture may define a certain set of architectural registers to be provided. The predetermined architecture would generally have been developed expecting the processing apparatus 2 to have sufficient registers 12 provided in hardware to accommodate all of the data associated with the set of architectural registers defined by the architecture.

However, providing hardware registers 12 is expensive in terms of circuit area and power consumption. To reduce the overhead associated with the hardware register set 12, the processing apparatus 2 can be provided with a set of hardware registers 12 with a capacity which is insufficient for storing all the state associated with the set of architectural registers defined by the predetermined architecture. Instead, a number of locations 50-62 in memory are allocated as register-emulating memory locations for storing the data associated with some architectural registers, which can be loaded into hardware registers 12 when required. The memory 6 generally has a lower circuit area per bit of data stored than the hardware registers 12, but takes longer to access, so this approach is particularly useful for relatively simple processors for applications where performance is not important but energy efficiency/area is a more important factor. This approach allows a significant reduction in the overall gate count of the processing apparatus 2. The hardware registers 12 can also be referred to as micro-architectural registers (as opposed to the architectural registers defined in the architecture).

For example, in a simple implementation of the ARMv6-M architecture, a significant proportion of the area may be consumed by the architected register file r0-r12, MSP, PSP, LR. By removing these registers and instead allocating a portion of system memory (e.g. a 64 byte portion) as a backing store for the registers and/or a scratch space for the processor to emulate having the full register file, this can permit implementations with a gate count of around 3000-4000, which represents a significant reduction in circuit area.

For example, as shown in FIG. 1, the hardware register set 12 may include:
an opcode register 30 for storing an opcode of a program instruction to be executed by the processing circuitry 4. The fetch circuitry 8 may fetch an instruction from the memory system 6 and load the opcode of the instruction into the opcode register 30. The decode circuitry 10 then decodes the opcode loaded into the opcode register 30 and controls the processing circuitry 4 to perform the corresponding processing operations.
a program counter (PC) register 32 for storing the program counter PC.
two general purpose operand registers 34, 36 (also referred to as registers RA, RB) for storing operands to be processed in response to a given instruction. While the architecture defines 13 general purpose operand registers R0-R12, the hardware register set 12 only has two operand registers RA, RB.
An offset register 38 for storing an offset value identifying a current phase of processing of the current instruction.
At least one bit 40 of register storage for storing the instruction set indicating value T.
At least one bit 42 of register storage for indicating the stack pointer selection value SPSEL.
Condition flag register storage 44 for storing the condition flags NZCV
One or more reference address registers 46, 48 for storing at least some of the breakpoint/watchpoint comparison addresses BP_COMPi, WP_COMPi.
   Note that the opcode register 30 and offset register 38 are not defined as architectural registers in the architecture as such, but are hardware registers provided in this particular implementation to streamline processing by the processing circuitry 4. The remaining hardware registers correspond to a subset of the architectural register state defined in the architecture (e.g. in the case of the PC, T, SPSEL, NZCV), or are general purpose registers 34, 36 into which any architectural state defined by the architecture can be loaded.

Hence, at least some of the architectural register state defined in the architecture does not have a permanent register provided in the hardware register set for storing that data. Register-emulating memory locations 50-62 are allocated in memory for storing such state. In this example, the register-emulating locations include locations corresponding to the general purpose architectural registers (R0 to R12) 50, the main stack pointer (MSP) register 52, the link register (LR) 54, process stack pointer register (PSP) 56, and breakpoint/watchpoint comparison registers 60, 62. It will be appreciated that other locations could be allocated in memory for other pieces of architectural state defined by the architecture.

The particular locations allocated in memory 6 for each architectural register may be selected arbitrarily. However, it can be more efficient to group them together in a given region of the address space. For example, a register-emulating region having a given base address #B can be allocated in the memory space. For ease of decoding the architectural register specifiers in instructions to map them to corresponding addresses in memory, the locations corresponding to general purpose registers R0 to R12 may be allocated to consecutive addresses starting from the base address #B so that the register number R0 to R12 of the corresponding architectural register can be mapped directly to the address offset of the required location relative to the base address #B. Similarly, the MSP, LR and PSP emulating locations 52, 54, 56 may be at offsets of 13, 14 and 15 respectively. In the case of the MSP and LR this maps directly to the register specifiers R13 and R14 used to refer to these registers in the ARMv6-M architecture. For PSP, this would normally map to R13 and the PC would map to R15, but as the PC already has a permanent hardware register 32, there is no need for a corresponding emulating location in memory, and so offset 15 can be used for the PSP.

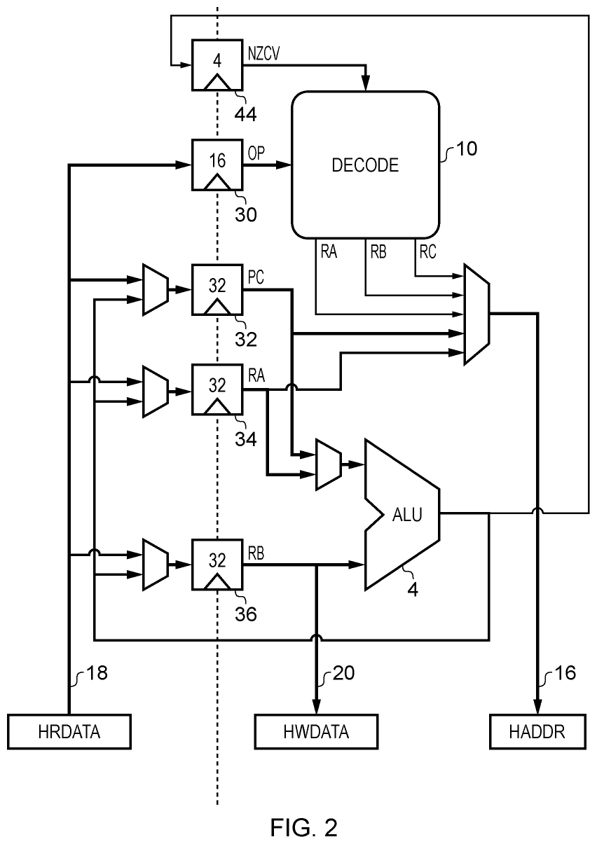

FIG. 2 schematically illustrates an example of a portion of the processing apparatus 2 for transferring data between the register-emulating memory locations 50-62 and the hardware registers 12. It shows only some of the hardware register set shown in FIG. 1 but it will be appreciated that the other hardware registers may still be provided. The opcode of an instruction to be processed is fetched into the opcode register 30. The decode circuitry 10 decodes the opcode from the opcode register 30 to generate addresses of the register-emulating memory locations for any required architectural state required for the current instruction. For example, most arithmetic or logical instructions may specify one or two source architectural registers which may be decoded into corresponding addresses RA, RB and a destination architectural register which may be decoded into a corresponding address RC. Other instructions may specify other kinds of register state and the address of the corresponding register-emulating memory locations may be output as one or more of the addresses RA, RB, RC. The addresses of any required architectural state are output over the address channel 16 of the memory bus 14 to the memory system 6. If more than one piece of architectural state is required then the addresses may be output over several read cycles. When the read data is returned from memory over the read channel 18, the data is loaded into one or more of the hardware registers, such as the program counter register 32 and the two operand registers 34, 36. The processing circuitry 4 in this example is an arithmetic/logic unit (ALU) for performing arithmetic or logical operations, but other examples of processing logic could also be provided. The processing circuitry 4 reads the values from the program counter register 32 or the operand registers 34, 36 to generate a result value which is written back into the second operand register 36 (RB). The address RC of the register-emulating memory location corresponding to the destination register is output over the address bus 16 in an address phase of a write cycle, followed by a data phase for outputting the result of the instruction over the write channel 20. The second operand register 36 is hardwired to the write channel 20 of the bus 14 so that the result of the program instruction is automatically written back to memory.

Hence, with a limited amount of register state storage provided in hardware, the program instructions according to the predetermined architecture can still be executed by using the memory to emulate having the full architecture register file.

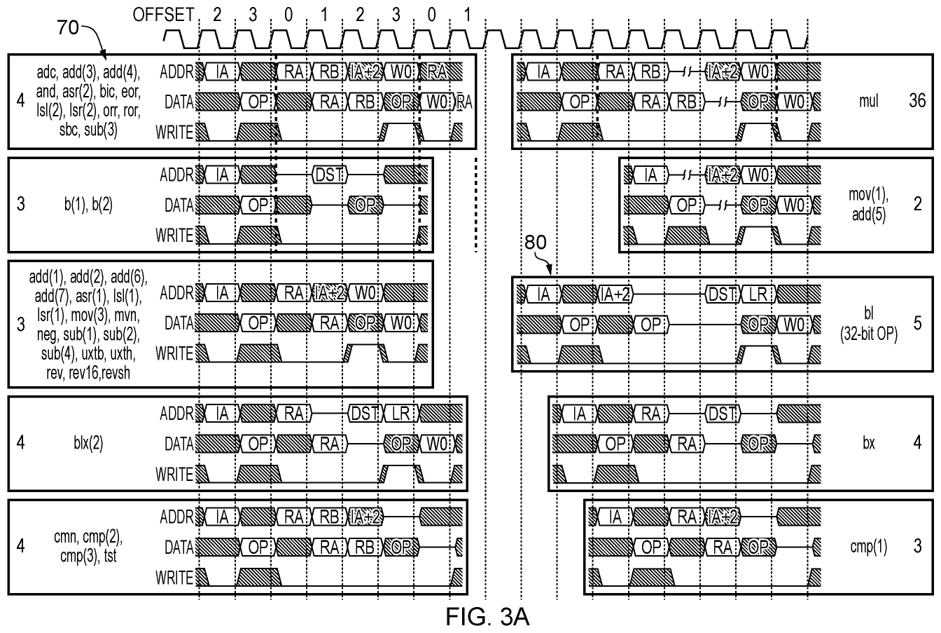

FIGS. 3A and 3B show a series of timing diagrams showing examples of timings of the read and write operations to memory 6 for different kinds of processing instructions. In this example the instructions are some of those specified by the ARMv6-M architecture but it will be appreciated that other architectures may define different sets of instructions. The ARMv6-M Architecture Reference Manual explains the operations corresponding to each type of instruction. In each timing diagram, the ADDR signals show the addresses output in each cycle, the DATA signals show the read data received from memory in each cycle or the write data sent to memory in each cycle, and the WRITE signals show whether the corresponding cycle is a read cycle (when WRITE is logic low) or a write cycle (when WRITE is logic high).

For example, the timing diagram 70 at the top left of FIG. 3A shows an example timing for the memory accesses required for several types of arithmetic instructions (e.g. add or subtract instructions adc, add, sbc, sub), logical instructions (e.g. and, orr, eor) or shift/rotate instructions (e.g. Isl, Isr, ror). As shown in the timing diagram 70, these instructions may require four cycles of reads or writes to memory when implemented with a reduced hardware register set 12 as discussed above:
A read cycle to output the instruction address IA of the instruction to memory, followed by the opcode OP of the instruction being returned from memory.
Two read cycles to output the addresses RA, RB of the register-emulating memory locations corresponding to first and second source architectural registers specified by the instruction, followed by return of the corresponding data from memory.
A write cycle to output the address W0 of the register-emulating memory location corresponding to the destination architectural register of the instruction, followed by outputting of the result data value generated in response to the instruction.

In each timing diagram shown in FIGS. 3A and 3B, the operations for a first instruction at address IA are shown unshaded and the operations for a following instruction at address IA+2 are shown shaded. The limited register resource present in the processing apparatus 2 can make traditional pipelining challenging. However the interaction with the bus 14 results in one instruction to instruction pipelining opportunity being deferring of the address phase of a register write back so that it occurs in parallel with the data phase of the opcode fetch for a second instruction. See the cycle indicated with an offset value of 3 in diagram 70 of FIG. 3A. Similarly, the address phase of one of the register reads RA for a second instruction occurs in parallel with the data phase of the register writeback W0 for a first instruction (see the cycle indicated with offset 0 in diagram 70). By deferring the write phase W0 for the first instruction by a cycle relative to the reads RA, RB, the opcode of the next instruction can be fetched before the writeback so that the opcode can be decoded and the register reads RA, RB for the next instruction can follow directly after the writeback W0 for the previous instruction. In contrast, if the write phase W0 for a given instruction occurred directly after the second read phase RB of the same instruction, then each instruction would require an additional cycle to be processed because the outputting of the address RA for the first register read would need to wait until after the cycle in which the opcode OP of the same instruction has been received and decoded. Delaying the write cycle until after the opcode fetch of the next instruction therefore improves performance.

As shown in the timing diagrams for the other types of instructions, the processing of the other instructions can be pipelined in a similar way so that the opcode fetch OP of the next instruction occurs before the writeback W0 for the preceding instruction. Hence, a series of instructions of different types can be pipelined in the same way as discussed above.

As shown in FIGS. 3A and 3B, different types of instructions may take a different number of cycles to complete. The number indicated to the left or right of each class of instructions indicates the number of cycles required per instruction, when processing is pipelined in the way discussed above. Each successive cycle for processing a given instruction corresponds to a different phase of processing. To distinguish which phase of processing of a given instruction is currently being performed, the offset register 38 stores an offset value which cycles through a series of values corresponding to each phase. The offset register 38 can be used to control the processing of the processing circuitry 4 and to select which addresses are output over the bus 14. For example, as shown in FIG. 3A, for the instructions indicated in diagram 70 the offset value may cycle between values 0, 1, 2, 3 to distinguish the four cycles of each instruction. It will be appreciated that which particular cycle is indicated with each value of the offset value is arbitrary and implementation dependent—in this example the cycles for outputting addresses RA, RB, IA and W0 correspond to offsets of 0, 1, 2 and 3 respectively, but other examples could choose a different mapping.

Most of the instructions may require relatively few cycles, and so an offset value with a certain number of bits (e.g. 4 or 5 bits) may be enough for handling most instructions. However, as shown in FIGS. 3A and 3B, some instructions may require more cycles—e.g. a multiply instruction for example may take a greater number of cycles, for example 36 cycles in this example.

One approach may be to provide the offset register 38 for accommodating the maximum number of different offset values required for any instruction defined by the architecture. However, this may require additional bitspace in the offset register which would not be used for most instructions. To avoid this extra overhead, a smaller offset register may be provided. If an instruction requires more bits than are provided in the offset register 38, then the instruction set indicating value 40 could be re-used to encode an additional bit of the offset value. For example, most types of instructions in the architecture may not be allowed to change the current instruction set, or some architectures may only support one instruction set but the instruction set indicating value 40 may still be provided for compatibility with legacy code written for an architecture supporting multiple instruction sets. Therefore, for many instructions the instruction set indicating value 40 may be redundant, and so by reusing it to store at least one additional bit of the offset value, larger offset values corresponding to instructions with larger numbers of phases can be encoded to avoid providing one or more additional bits in the offset register 38 which would be unused for most instructions. This allows a further reduction in the overall size of the hardware register set 12.

In the example of FIG. 1, the opcode register 30 is 16 bits wide. In the ARMv6-M architecture, most instructions are 16-bit instructions, but there are also a few 32-bit instructions. Making the opcode register 32 bits wide to accommodate the largest instructions would incur extra area cost in providing additional bits of register storage which would remain unused for most instructions. A more area-efficient implementation is to provide a 16-bit opcode register 30. For the few 32-bit instructions in the architecture, an initial 16-bit prefix portion can be loaded into the opcode register 30 and partially decoded by the decode circuitry 10 to identify that it is part of a 32-bit instruction, and the decode circuitry can then trigger fetching of the remaining part of the 32-bit opcode into one of the operand registers 32, 34 in a subsequent cycle. For example, see the timing diagram 80 of FIG. 3A for a bl instruction (branch with link) in which there are two instruction fetch cycles for outputting the addresses IA, IA+2 of successive 16-bit chunks of the instruction opcode and returning the corresponding portions of the opcode OP from memory. By storing part of the opcode into one of the general purpose operand registers (which is not required in any case for this type of instruction), it is not necessary to provide a 32-bit opcode register. A similar approach can be taken for any instruction having a larger opcode than can fit in the hardware opcode register 30.

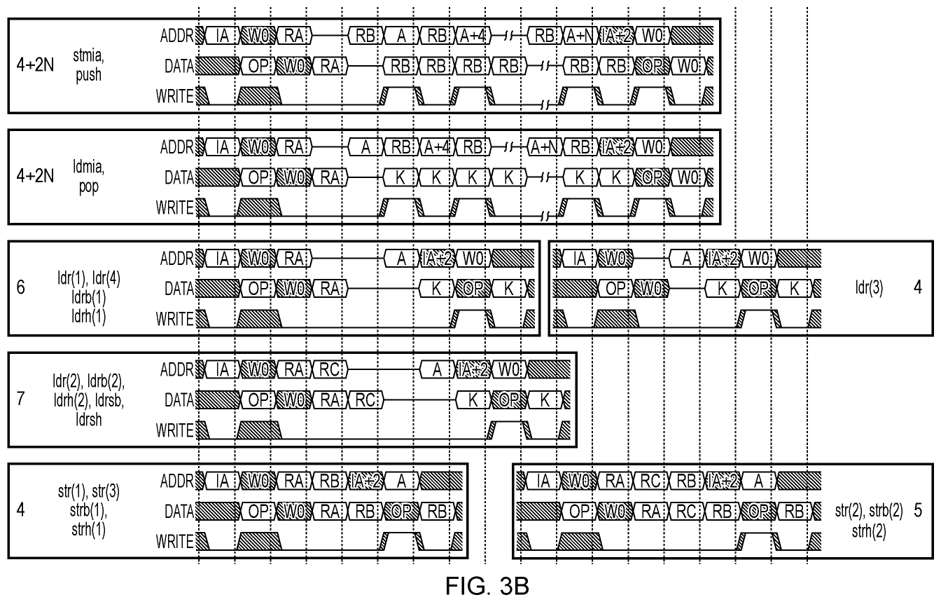

FIG. 4 is a flow diagram showing an example of processing an instruction using the reduced hardware register set. At step 100, an R-bit opcode is fetched into the opcode register 30. At step 102, the decode circuitry 10 identifies whether the R-bit opcode represents an R-bit prefix of an S-bit opcode. For example, the S-bit instructions may have an initial R-bit portion which is not the same as any R-bit instruction, to allow the decode circuitry 10 to identify that there are further bits to come. If the fetched R bits does represent the prefix portion of a S-bit instruction, then at step 104, the decode circuitry 10 triggers a second instruction fetch cycle to load the remaining bits into operand register 34 or 36. At step 106, the decode circuitry 10 then decodes both portions of the opcode to generate the control signals for controlling the processing circuitry 4. On the other hand, if at step 102 the originally fetched R-bit opcode is not part of a larger S-bit instruction, then the R-bit opcode is simply decoded at step 108 and there is no need for a second fetch cycle. For ARMv6-M, R=16 and S=32, but other architectures may specify other sizes of opcode.

Having decoded the opcode of the instruction, at step 110 the decode circuitry outputs addresses for the register-emulating memory locations corresponding to the architectural registers targeted by that instruction. At step 112, the data associated with those architectural registers is received from memory and stored into some of the hardware registers 12. At step 114, the processing circuitry performs the processing operation corresponding to the decoded instruction using the data in the hardware registers 12. At step 116, the address corresponding to the destination architectural register is output to memory and then the result of the instruction is written back to the location in memory. While FIG. 4 shows these operations occurring sequentially, it will be appreciated that the address and data phases for each memory access can be pipelined in the way shown in FIGS. 3A and 3B.

FIG. 1 shows an example where only two operand registers 34, 36 are provided in hardware in the hardware register set 12. Other examples could have more than two operand registers, but fewer operand registers than there are general purpose registers defined in the architecture. However, two registers may be enough to implement most instructions, because for most arithmetic or logical instructions, once the two input operands have been input into the ALU, they are not required again and the result can be written back to one of the operand registers 34, 36 used to store the input operands.

However, for some instructions, two operand registers may not provide enough storage. For example, some instructions which may require additional working register space in order to be able to calculate the result of the instruction. For example, a multiply or divide instruction may typically perform the multiply or divide operation in an iterative process comprising a number of steps, where each step takes one or more bits of the input operands and updates an accumulator value resulting from the previous step. As the accumulator value typically needs to be accumulated before all of the bits of the input operands have been consumed, one would generally expect at least three hardware registers to be provided, two for the inputs and one for the accumulator value.

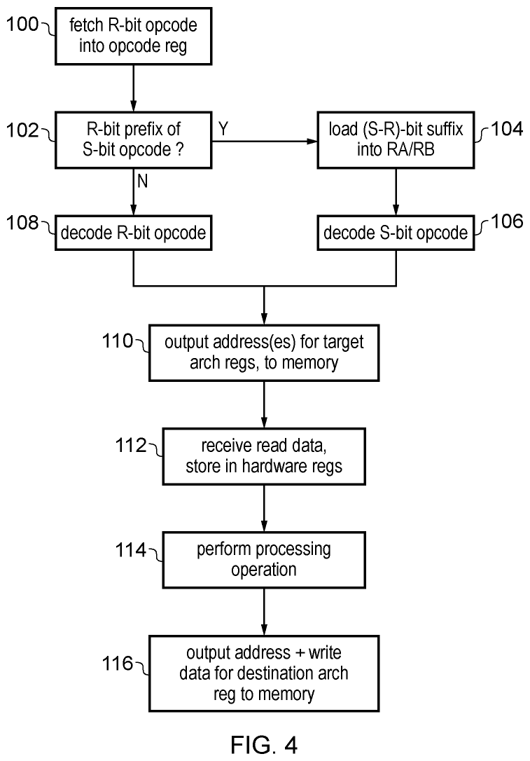

FIG. 5 shows an example of a technique for making more register space available for instructions which need it. In this example, the program counter can temporarily be written from the program counter register 32 to a corresponding location in the memory system 6 to make extra space available for the processing operation to be performed. For example, a multiply or divide instruction may use the program counter 32 as the primary accumulator for accumulating the results. Once the processing operation has completed, then the program counter can be recovered and written back to the program counter register 32 ready for the next instruction. This avoids the need to provide an additional operand register which would only be used by a few instructions, greatly reducing area and the power of it.

At step 120 of FIG. 5, a next instruction is fetched and decoded. At step 122, the decoder determines whether the instructions are a predetermined type of instruction which requires more than the two operand registers of state storage. If not then at step 124 the instruction is processed in some other way. On the other hand, if the instruction is of the predetermined type then at steps 125 and 126 the read operations for reading the operands required by the instruction from memory are performed in the same way as steps 110 and 112 of FIG. 4. At step 128, the program counter is written out to memory. For example, a given memory address may be reserved for receiving the program counter when required, and when detecting the predetermined type of instruction, the decoder can decode the opcode and output the given address to memory followed by the program counter value itself. Alternatively, if the predetermined type of instruction is an instruction of the form Rd=Rd*Rm where the destination register is the same as one of the source registers, the state associated with Rd will be written back to memory following the processing of the instruction, so it is safe to temporarily store the PC to the register-emulating memory location corresponding to the destination architectural register Rd, so that it is not necessary to allocate an additional memory location for storing the PC.

At step 130, the operation associated with the predetermined type of instruction, such as a multiply or divide, can then be performed using the program counter hardware register 32 for storing a value during the operation. For example, the program counter could be used for storing one of the operands of the operation, or for an intermediate or final result of the operation (e.g. the accumulator value of the multiply or divide). At step 132 the program counter is then loaded back from memory and returned to program counter register 32. At step 134, the result of the predetermined type of instruction is written to the register-emulating memory location corresponding to the destination register.

Alternatively, some forms of multiply instruction can be executed using only the two operand registers 34, 36, without needing to use the program counter register. Some architectures may support a multiply instruction which multiplies two N-bit operand values to generate an N-bit result which corresponds to the least significant N-bits of the product of the two operands. For example, in the ARM V6-M architecture, such a multiply instruction is the only supported multiply instruction. Hence, it is not necessary to calculate the upper N-bits of the product for these instructions. In this case, the requirement to only implement a half width result means that one additional bit per cycle of the multiplier is redundant per bit of product computed and so the bits of the accumulator are generated at the same rate the bits of one of the operands are consumed. This means that one of the operand registers used to hold an input operand can be used to accumulate the result value, with bits of that operand being shifted out to make way for bits of the accumulator.

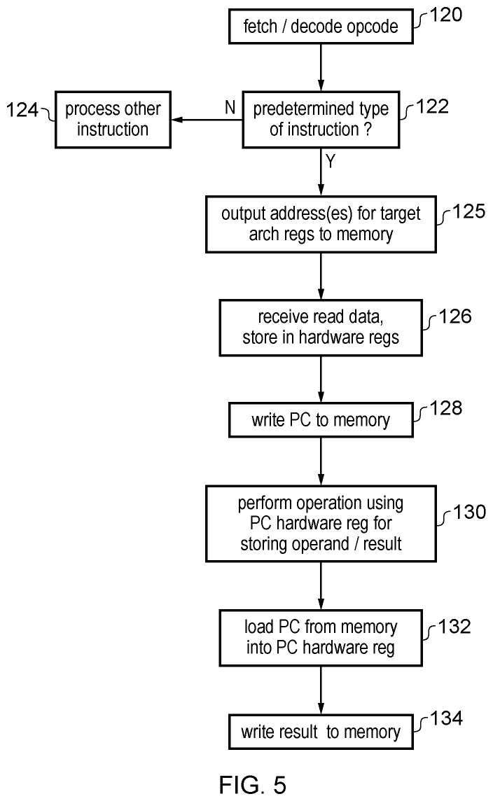

FIG. 6 shows an example for implementing such a multiply instruction. An N-bit result representing the lower N bits of the product of two N-bit operands RA, RB can be generated using a series of N steps, with each step i (1≤i≤N) comprising operations equivalent to the following operations:

1. a. in step 1: ACC′=MSB[RB] ? RA
b. in steps 2 to N: ACC′=RB<<1+MSB[RB] ? RA where RB<<1 is RB left shifted by one bit position (i.e. all bits are shifted up one position and a 0 is inserted in the least significant bit),
   MSB[RB] ? RA=RA if the most significant bit of RB is 1, or =0 if the most significant bit of RB is 0.
   ACC′ is a temporary accumulator value for the current step.
   2. SHIFT=RB<<1 (left shift RB by one place)
   3. MASK=11111111 . . . <<i (generate a mask by left shifting an N-bit value whose bits are all 1 by a number of bit positions corresponding to the number of the current step of the process)

### 4. RB′=(SHIFT & MASK)+(ACC′ & ˜MASK)

(update register RB for the next iteration so that bits corresponding to a 1 in the mask take the corresponding bit values of SHIFT and bits corresponding to a 0 in the mask take the corresponding values of ACC′).
RB′ is then used as input RB for the following step. At the end of step N, the result RB′ will be equal to the lower N bits of the product of original input operands RA, RB.

Note that in practice hardware for implementing the multiply operation need not actually carry out these operations, and may perform any operations which give an equivalent result. For example, the hardware may not actually calculate ACC′.

In FIG. 6, step 1 is implemented using a multiplexer 204 for selecting between 0 and result of a shifter 215 which left shifts register RB 36 by one bit position depending on whether the current step is step 1 or a subsequent step, and an adder 202 which adds the output of multiplexer 204 to the output of multiplexer 200 which selects between the value of register RA and 0 depending on the most significant bit of register RB. The shifter 215 also implements the shifting step 2. The mask in step 3 is generated by shifter 220, and this controls packing of respective portions of SHIFT and ACC 206 into the register RB to produce the RB′ input to be used for the following cycle. It will be appreciated that other embodiments may use different hardware.

A worked example of a multiplication is shown to illustrate the procedure. For conciseness, the example is shown using 4-bit operands (i.e. N=4), but it will be appreciated that in most architectures the operands would be larger. At each step, the symbol “|” in RB or RB′ denotes the division between the upper portion which represents remaining bits of the original input operand RB, and the lower portion which represents bits of the accumulator value corresponding to a sum of partial products of RA with the already shifted out bits of RB.

Input operands: RA=0b0111 (=decimal 7)
RB=0b1011 (=decimal 11)

### Step 1:

| 1a. | RA = 0b0111 RB = 0b1011\| |
|---|---|
| | MSB[RB] = 1, so ACC′ = RA = 0b0111 |
| 2. | SHIFT = RB << 1 = 0b0110 |
| 3. | MASK = 0b1111 << 1 = 0b1110 |
| 4. | RB′ = SHIFT & MASK + ACC′ & ~MASK = 0b011\|1 |

### Step 2:

| 1b. | RA = 0b0111 RB = 0b011\|1 |
|---|---|
| | MSB[RB] = 0, so ACC′ = RB << 1 + 0 = 0b1110 |
| 2. | SHIFT = RB << 1 = 0b1110 |
| 3. | MASK = 0b1111 << 2 = 0b1100 |
| 4. | RB′ = SHIFT & MASK + ACC′ & ~MASK = 0b11\|10 |

Step 3:

| 1b. | RA = 0b0111 RB = 0b11\|10 |
|---|---|
| | MSB[RB] = 1, so ACC′ = RB << 1 + RA = 0b1100 + |
| | 0b0111 = 0b0011 |
| 2. | SHIFT = RB << 1 = 0b1100 |
| 3. | MASK = 0b1111 << 3 = 0b1000 |
| 4. | RB′ = SHIFT & MASK + ACC′ & ~MASK = 0b1\|011 |

Step 4:

| 1b. | RA = 0b0111 RB = 0b1\|011 |
|---|---|
| | MSB[RB] = 1, so ACC′ = RB << 1 + RA = 0b0110 + |
| | 0b0111 = 0b1101 |
| 2. | SHIFT = RB << 1 = 0b0110 |
| 3. | MASK = 0b1111 << 4 = 0b0000 |
| 4. | RB′ = SHIFT & MASK + ACC′ & ~MASK = 0b\|1101. |

Note that in the final step all bits of the mask will be zero, so parts 2-4 of step 4 could be omitted and instead ACC′ could simply be output as the final result. However, in terms of hardware it may be simpler to generate the mask to combine SHIFT and ACC′ in a corresponding way to the earlier steps, rather than attempting to extract ACC′ at an earlier step.

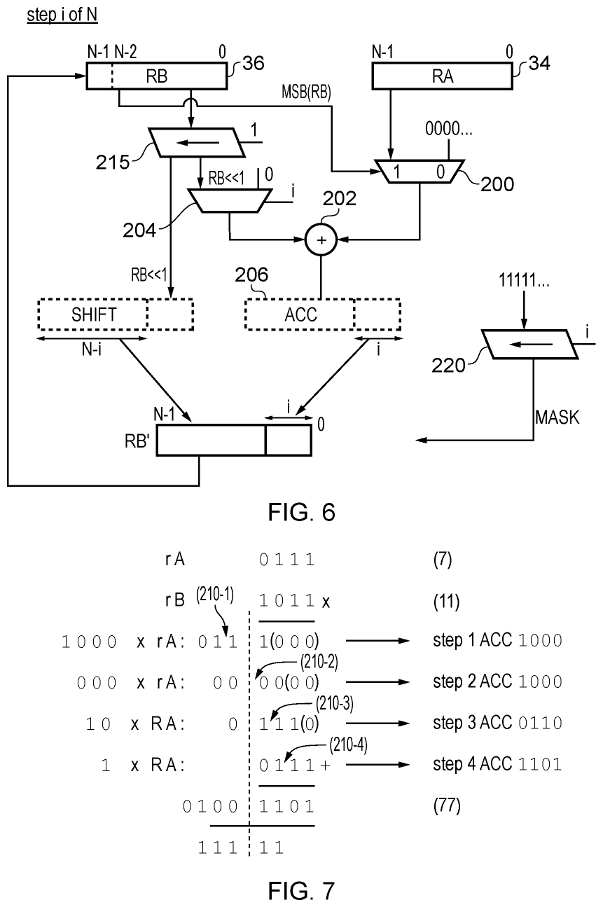

To help understand why this process works, FIG. 7 shows the same multiplication of 0b01111 and 0b1011 using long multiplication. The bottom 4-bits of the product are output as the result RB′ in step 4. As shown in FIG. 7, the result 0b1101 given above is correct.

Note that the result value is essentially the sum of four partial products 210 of the first operand value RA with respective bits of the second operand RB when weighted by the appropriate multiplying factor corresponding to their bit position. At each step, only one bit of operand RB is required to be multiplied with RA, and after a given step, that bit of operand RB is not used anymore, which is why one bit of RB can be shifted out in each step of the process. The left shifting of RB at parts 1 and 2 of each step accounts for the fact that an extra 0 is brought in at each step so that the partial product for that step is added 1 place to the right of the accumulator resulting from the preceding step.

Also, FIG. 7 shows that in the partial product 210-1 of the most significant bit of RB with RA, only one bit of the partial product will contribute to the end result because the other three bits are more significant than the lower 4 bits used for the result. This is why it is enough to insert only one bit of ACC′ into operand register RB in step 1. More generally, in step i, only i bits of the partial product 210-i contributes to the result, so step i requires i bits of ACC′ to be inserted into register RB. As the number of additional bits in each step is 1, which matches the number of input operand bits of RB per step that are not required anymore, the accumulator can be inserted into the RB register as bits of the original input operand are shifted out, to avoid needing any additional register space.

Also, the right hand part of FIG. 7 shows the lowest 4-bits of the running total of the i partial products calculated in step i and any preceding step. Note that these running totals correspond exactly to the accumulator bits inserted in the right hand portion of RB′ at part 4 of each step, when padded on the right with 0s to fill up 4 bits in total:

| | | |
|---|---|---|
| Step 1: | RB′ = 0b011\|1 | i.e. accumulator of 0b1(000) |
| Step 2: | RB′ = 0b11\|10 | i.e. accumulator of 0b10(00) |
| Step 3: | RB′ = 0b1\|011 | i.e. accumulator of 0b011(0) |
| Step 4: | RB′ = 0b\|1101 | i.e. accumulator (and final result) of 0b1101 |

Hence, this approach can be used for multiply instructions which generate an N-bit result representing the lower N bits of the product of two N-bit operands, to allow the instruction to be executed using only two operand registers. Other types of multiply instruction (e.g. instructions for generating a full 2N-bit product value), can be implemented instead by using the technique of writing the program counter to memory as discussed above with respect to FIG. 5.

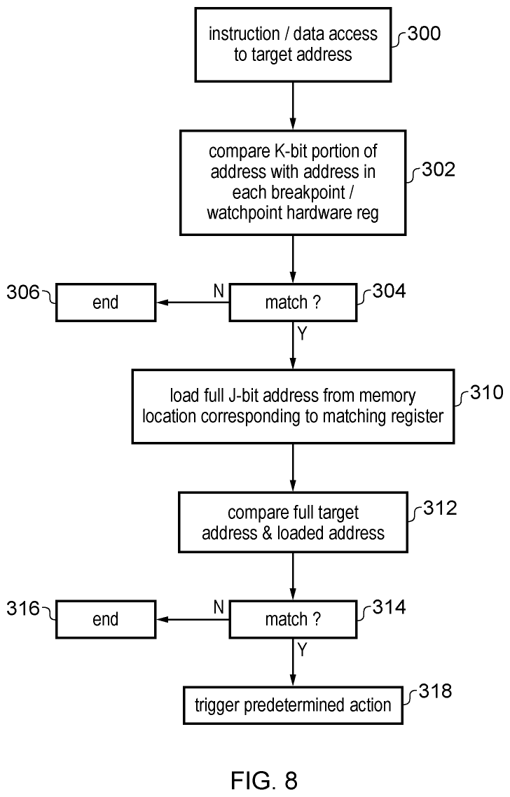

FIG. 8 is a flow diagram explaining the use of the breakpoint or watchpoint registers 46, 48. As discussed above, the architecture may define breakpoint/watchpoint comparison registers 60, 62 for storing reference addresses for comparing against the target addresses of instruction fetches (for breakpoints) or data accesses (for watchpoints), so that a given action can be triggered when there is a match. This can be useful for debugging or other diagnostic purposes. The action triggered on a matching watchpoint or breakpoint could include halting processing of program instructions, triggering an exception, switching to a debug mode for allowing debug instructions to be injected for processing by the processing circuitry 4, or outputting some diagnostic data indicating the current state of the processor, for example.

Some implementations may choose not to provide any debug functionality, to save circuit area, since the debug functionality may be an optional feature for assisting with software development which is not actually required for correct program execution. However, debugging can be a useful feature so other implementations may seek to provide some hardware resources for enabling these features.

The debug functionality is not always used and so incurring circuit area and power consumption overhead in providing hardware registers 12 for all the breakpoint and watchpoint comparison registers 60, 62 defined by the architecture may not be justified.

Alternatively, no hardware registers could be provided for the breakpoint/watchpoint architectural registers 60, 62, and instead all breakpoint/watchpoint reference addresses may be stored in corresponding locations in memory. However, this may be slow in terms of performance since this would require many additional memory accesses on every instruction fetch (one additional read cycle per enabled breakpoint) and on every data access (one additional read cycle per enabled watchpoint). This may be unacceptable in terms of performance slow down.

To avoid this additional performance cost, but reduce the area overhead of providing hardware registers, the hardware register set 12 may include K-bit breakpoint or watchpoint registers 46, 48 which are smaller than the J-bit breakpoint/watchpoint registers 60, 62 defined in the architecture. The hardware breakpoint or watchpoint registers 46, 48 store a K-bit portion of the reference addresses associated with corresponding architectural breakpoint/watchpoint comparison registers 60, 62. The full J-bit reference addresses are actually stored in corresponding register-emulating memory locations in the memory system 6. The hardware breakpoint/watchpoint registers 46, 48 allow an initial K-bit comparison of a portion of current instruction/data target addresses with the K-bit reference addresses stored in each enabled breakpoint/watchpoint register 46, 48. A control register can control which breakpoints/watchpoints are enabled. If there is a match in the K-bit comparison, this then triggers fetching of the full J-bit reference addresses from memory 6 and a subsequent J-bit comparison to determine whether the current target address of the instruction fetch or data access actually matches the J-bit breakpoint/watchpoint reference address defined in the architecture. Hence, the hardware reference address registers 46, 48 act as a filter so that the performance cost of fetching in the actual breakpoint or watchpoint comparator addresses from memory is only incurred when the K-bit portions match. The hardware registers can perform the K-bit comparison much faster than the J-bit comparison to memory, but require less circuit area than a J-bit hardware register.

As shown at FIG. 8, at step 300 the processing apparatus 2 performs an instruction fetch or a data access from a target address in memory. At step 302, comparators 320 provided in hardware in the processing apparatus 2 compare a K-bit portion of the target address with the K-bit contents of each enabled breakpoint register (for instruction fetches) and each enabled watchpoint register 48 (for data accesses). In some examples, the comparison could be performed by comparators already provided within the processing circuitry 4 for other purposes. Alternatively, some additional comparators may be provided for breakpoint/watchpoint comparisons. At step 304, the comparators determine whether the K-bit portions match. If there is no match then at step 306 the method ends and there is no fetching of the architectural breakpoint or watchpoint reference addresses from memory. This avoids slowing down performance on every memory access.

On the other hand, if the K-bit portions match, then at step 310 the full reference address is fetched from the register-emulating memory location which corresponds to the particular breakpoint/watchpoint hardware register 46, 48 for which a match was detected. Note that even when there is a match, the performance overhead is still lower than if there were no hardware breakpoint/watchpoint registers 46, 48, because only the J-bit reference address for the matching breakpoint/watchpoint needs to be fetched from memory, not reference addresses for all breakpoints/watchpoints. At step 312, the full J-bit reference address is compared with all J bits of the target address. Again, the comparator 320 determines at step 314 whether there is a match, and if not the method ends at step 316, and if there is a match then at step 318 a pre-determined action is taken. For example, the pre-determined action to be taken could be any of the examples discussed above, and could be specified in a control architectural register. In some cases the data of the control architectural register may also need to be fetched from a register-emulating memory location when there is a matching breakpoint or watchpoint.

In some cases, there may be fewer hardware breakpoint/watchpoint registers 46, 48 than the number of architectural breakpoint/watchpoint registers 60, 62 defined in the architecture. In this case, if more than the number of hardware breakpoint/watchpoint registers 46, 48 are enabled, then there may still need to be some fetching of reference addresses from memory on each instruction/data accesses. This can be avoided by providing enough hardware comparison registers 46, 48 to correspond to each of the architectural comparison registers 60, 62.

FIG. 8 shows an example where the K-bit reference address stored in the hardware breakpoint/watchpoint registers 46, 48 is simply a K-bit portion of the J-bit reference address of the corresponding architectural breakpoint/watchpoint register 60, 62. However, in other examples the K-bit reference address could be obtained by applying a hash function to the J-bit reference address. In this case, in response to a memory access for a given target address, the corresponding hash function could be applied to the target address, and then the result of the hash function can be compared against the K-bit reference address to determine whether the J-bit reference address needs to be loaded from memory.

In another example, an apparatus comprises:

means for processing program instructions in accordance with a predetermined architecture defining a plurality of architectural registers accessible in response to the program instructions; and

a set of hardware register means for storing data, wherein a storage capacity of the set of hardware register means is insufficient for storing data associated with all of the plurality of architectural registers of the predetermined architecture; and

means for transferring, in response to the program instructions, data between the set of hardware register means and at least one register-emulating memory location in memory for storing data corresponding to at least one of the plurality of architectural registers of the predetermined architecture.

In another example, an apparatus comprises:

means for performing data processing in response to program instructions;

program counter register means for storing a program counter identifying a program instruction to be processed; and

means for writing the program counter to memory in response to a predetermined type of instruction to be processed by said means for performing data processing;

wherein the means for performing data processing is configured to use said program counter register means for storing at least one data value during processing of said predetermined type of instruction.

In another example, an apparatus comprises:

means for performing data processing in response to program instructions;

at least one operand register means for storing at least one operand value;

an R-bit opcode register means for storing an opcode of a program instruction to be processed by the means for performing data processing; and

means for loading, in response to a program instruction having an S-bit opcode, where S>R, an R-bit portion of the opcode into the opcode register means and loading a remaining portion of the opcode into one of said at least one operand register means.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. An apparatus comprising:
processing circuitry to process program instructions in accordance with a predetermined architecture defining a plurality of architectural registers accessible in response to the program instructions; and
a set of hardware registers, wherein a storage capacity of the set of hardware registers is insufficient for storing data associated with all of the plurality of architectural registers of the predetermined architecture; and
control circuitry responsive to the program instructions to transfer data between the set of hardware registers and at least one register emulating memory location in memory for storing data corresponding to at least one of the plurality of architectural registers of the predetermined architecture;
wherein the set of hardware registers comprises a program counter register to store a program counter identifying a program instruction to be processed by the processing circuitry; and
in response to a predetermined type of instruction for triggering the processing circuitry to perform a processing operation, the control circuitry is configured to write the program counter to memory, and the processing circuitry is configured to use the program counter register to store at least one data value during processing of said predetermined type of instruction.

2. The apparatus according to claim 1, wherein following said processing operation, the control circuitry is configured to read the program counter from memory and store said program counter to said program counter register.

3. The apparatus according to claim 1, wherein the predetermined type of instruction comprises a multiply or divide instruction.

4. The apparatus according to claim 1, wherein the predetermined type of instruction comprises an instruction specifying a given architectural register as both a destination register and a source register; and
in response to the predetermined type of instruction, the control circuitry is configured to write the program counter to the register emulating memory location corresponding to said given architectural register.

5. The apparatus according to claim 1, wherein the set of hardware registers comprises two N-bit operand registers to store operand values to be processed by the processing circuitry.

6. The apparatus according to claim 5, wherein in response to a multiply instruction for controlling the processing circuitry to multiply two N-bit operand values stored in the two operand registers to generate an N-bit result value representing a least significant N bits of a product of the two N-bit operand values, the processing circuitry is configured to accumulate the N-bit result value into one of said two operand registers.

7. The apparatus according to claim 6, wherein in response to the multiply instruction, the processing circuitry is configured to perform an iterative process for generating the N-bit result value in a plurality of steps, each step comprising shifting out a bit of one of the operand values from said one of said two operand registers to accommodate an additional bit of an accumulator value representing a sum of partial products of said two operand values.

8. The apparatus according to claim 1, wherein the set of hardware registers comprises an R-bit opcode register to store an opcode of a program instruction to be processed by the processing circuitry; and
the predetermined architecture supports at least one instruction having an S-bit opcode, where S>R; and
in response to an instruction having the S-bit opcode, the control circuitry is configured to load an R-bit portion of the opcode into the opcode register, and to load a remaining portion of the opcode into at least one further register of the set of hardware registers.

9. The apparatus according to claim 8, wherein the control circuitry comprises:
fetch circuitry to fetch an R-bit portion of the opcode of a next instruction from memory into the opcode register; and
decode circuitry to detect whether the R-bit portion fetched by the fetch circuitry corresponds to an R-bit portion of an S-bit opcode, and when the fetched R-bit portion corresponds to an R-bit portion of the S-bit opcode, to trigger fetching of the remaining portion of the S-bit opcode into the at least one further register.

10. The apparatus according to claim 1, wherein the set of hardware registers comprises at least one register bit to store an instruction set indicating value for indicating which of a plurality of instruction sets is a current instruction set from which the processing circuitry is executing instructions;
wherein in response to at least one predetermined type of instruction, the processing circuitry is configured to reuse said at least one register bit to indicate at least part of a parameter other than said instruction set indicating value.

11. The apparatus according to claim 10, wherein said at least one predetermined type of instruction comprises a type of instruction following which a change of instruction set is prohibited by the predetermined architecture.

12. The apparatus according to claim 10, wherein the set of hardware registers comprises an offset register to store an offset value for tracking a current phase of processing of a program instruction by the processing circuitry; and
for said at least one predetermined type of instruction, at least one additional bit of said offset value is encoded using said at least one register bit.

13. The apparatus according to claim 1, wherein the plurality of architectural registers comprise an architectural diagnostic register for storing a J-bit reference address for which a predetermined action is to be triggered when a J-bit target address of a current memory access matches the reference address; and
the apparatus comprises a comparator to compare the J-bit target address of the current memory access with a J-bit reference address loaded from a register emulating memory location in memory corresponding to the architectural diagnostic register, to determine whether to trigger said predetermined action.

14. The apparatus according to claim 13, wherein the set of hardware registers comprises a hardware diagnostic register to store a K-bit reference address corresponding to the J-bit reference address of said architectural diagnostic register, where K<J; and
the apparatus comprises comparison circuitry to detect whether the target address matches the K-bit reference address stored in the hardware diagnostic register, and when a match is detected, to trigger loading of the J-bit reference address from the register emulating memory location corresponding to the architectural diagnostic register.

15. A data processing method comprising:
receiving a program instruction to be processed according to a predetermined architecture defining a plurality of architectural registers accessible in response to the program instructions;
transferring data corresponding to at least one architectural register from a corresponding register emulating memory location in memory to at least one of a set of hardware registers, wherein a storage capacity of the set of hardware registers is insufficient for storing data associated with all of the plurality of architectural registers of the predetermined architecture; and
processing the program instruction using the set of hardware registers;
wherein the set of hardware registers comprises a program counter register to store a program counter identifying a program instruction to be processed by the processing circuitry; and
in response to a predetermined type of instruction for triggering the processing circuitry to perform a processing operation, the control circuitry is configured to write the program counter to memory, and the processing circuitry is configured to use the program counter register to store at least one data value during processing of said predetermined type of instruction.

16. An apparatus comprising:
processing circuitry to perform data processing in response to program instructions;
a program counter register to store a program counter identifying a program instruction to be processed; and
control circuitry to write the program counter to memory in response to a predetermined type of instruction to be processed by said processing circuitry;
wherein the processing circuitry is configured to use said program counter register for storing at least one data value during processing of said predetermined type of instruction.
